(19) United States
(12) Patent Application Publication
(10) Pub. No.: US 2007/0120761 A1
(43) Pub. Date: May 31, 2007

(54) High performance compact half wave antenna

(75) Inventor: Alejandro Candal, Davie, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/290,199

(22) Filed: Nov. 30, 2005

(51) Int. Cl. H01Q 1/36; H01Q 1/24

(52) U.S. Cl. 343/895; 343/702

(57) ABSTRACT

An antenna (100) that includes an outer helical radiator (102) having a first diameter (118) and an inner helical radiator (112) having a second diameter (116) that is smaller than the first diameter. The inner helical radiator can be positioned at least in part interior to the outer helical radiator. Further, the outer helical radiator and the inner helical radiator can be substantially coaxially aligned. For example, the inner helical radiator can be attached to a dielectric member (120) such that the dielectric member maintains the position of the inner helical radiator.

### BACKGROUND OF THE INVENTION

1. Field of the Invention

The present invention generally relates to antennas and, more particularly, to half wave antennas.

2. Background of the Invention

In response to consumer demand, new mobile communication devices continue to be developed which are dimensionally smaller than previous models. For example, some communication devices that are now being developed are significantly shorter and thinner than models that they will replace. Such devices can be easily carried in one's pocket, making their use convenient.

Unfortunately, making a mobile communication device dimensionally smaller creates challenges for the RF engineer. In particular, as antennas for the devices become smaller, engineers are forced to operate the antennas in quarter-wave mode. With all other parameters being equal, the specific absorption rate (SAR) of an antenna in quarter-wave mode is higher than the SAR of an antenna operating in half-wave mode.

### SUMMARY OF THE INVENTION

The present invention relates to an antenna that includes an outer helical radiator having a first diameter and an inner helical radiator having a second diameter that is smaller than the first diameter. The inner helical radiator can be positioned at least in part interior to the outer helical radiator. The outer helical radiator and the inner helical radiator can be substantially coaxially aligned. For example, the inner helical radiator can be attached to a dielectric member such that the dielectric member maintains the position of the inner helical radiator interior to the outer helical radiator.

The antenna also can include a whip to which the inner helical radiator is attached. The inner helical radiator can be movable between a first position wherein at least a portion of the inner helical radiator is positioned interior to the outer helical radiator, and a second position wherein the inner helical radiator is positioned exterior to the outer helical radiator. Further, the antenna can include a dielectric member that insulates the inner helical radiator from the outer helical radiator when the inner helical radiator is in the first position.

The outer helical radiator can be communicatively linked to a signal source. In addition, the inner helical radiator can be communicatively linked to the signal source when the inner helical radiator is in the second position.

The present invention also relates to a method for tuning performance characteristics of an antenna. The method can include positioning at least a portion of an inner helical radiator interior to an outer helical radiator having a first diameter. The inner helical radiator can have a second diameter smaller than the first diameter. The method also can include coaxially aligning the outer helical radiator and the inner helical radiator. The inner helical radiator can be insulated from the outer helical radiator with a dielectric member.

The inner helical radiator can be electrically connected to a whip such that the inner helical radiator is movable between a first position wherein at least a portion of the inner helical radiator is positioned interior to the outer helical radiator, and a second position wherein the inner helical radiator is positioned exterior to the outer helical radiator.

The outer helical radiator can be communicatively linked to a signal source. The inner helical radiator can remain unconnected to the signal source when the inner helical radiator is in the first position, and the inner helical radiator can be communicatively linked to the signal source when the inner helical radiator is in the second position.

### BRIEF DESCRIPTION OF THE DRAWINGS

Preferred embodiments of the present invention will be described below in more detail, with reference to the accompanying drawings, in which:

FIG. 1 depicts a side view of an antenna that is useful for understanding the present invention.

FIG. 2 depicts a top view of the antenna of FIG. 1.

FIG. 3 depicts a side view of another arrangement of the antenna that is useful for understanding the present invention.

FIG. 4 depicts the extendable antenna of FIG. 3 in an extended position.

FIG. 5 depicts a top view of the antenna of FIG. 3.

FIG. 6 is a flowchart which is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a high performance compact half-wave antenna. More particularly, the antenna of the present invention achieves a low specific absorption ratio (SAR) and a voltage standing wave ratio (VSWR) that is at least very near the ideal value of 1. Both of these performance specifications are achieved even though the antenna is small enough to be compactly integrated into today's very small mobile communication devices.

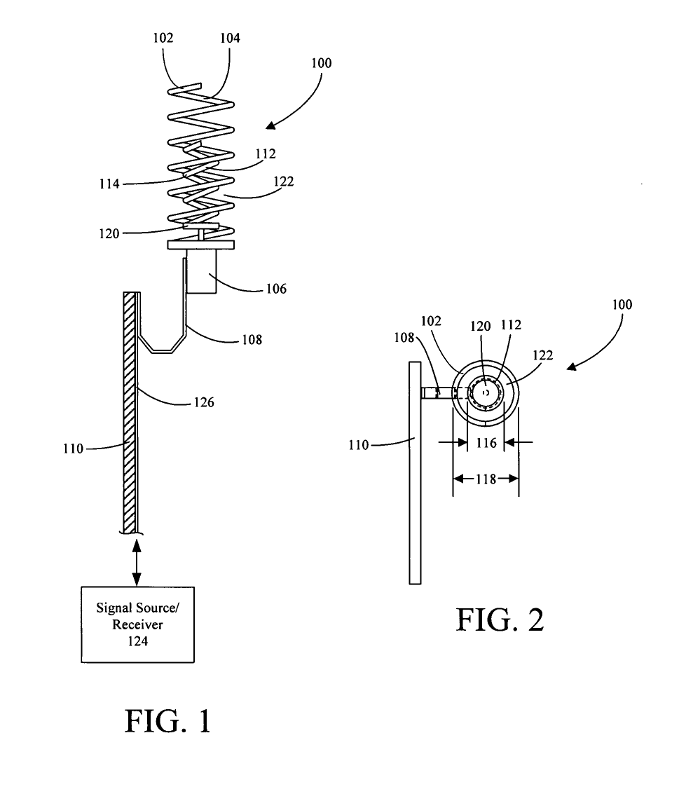

FIG. 1 depicts a side view an antenna 100 which is useful for understanding the present invention. FIG. 2 depicts a top view of the antenna 100. Making reference both to FIG. 1 and to FIG. 2, the antenna can include an outer helical radiator 102 that comprises a helically wound electrical conductor 104. The outer helical radiator 102 can be communicatively linked to a signal source and/or a signal receiver 124. For instance, the outer helical radiator 102 can be communicatively linked to the source/receiver 124 via a conductive member 106 and a contact 108. The contact 108 can provide electrical continuity with one or more circuit traces 126 on a printed circuit board 110 to which the source/receiver 124 is communicatively linked. The conductive member 106 can be T-shaped, as shown, although the invention is not limited in this regard. Indeed, the conductive member 106 can be any shape suitable for providing an electrical connection to the outer helical radiator 102.

The antenna 100 also can include an inner helical radiator 112 that comprises a helically wound electrical conductor 114. A diameter 116 of the inner helical radiator 112 can be smaller than a diameter 118 of the outer helical radiator 102. This configuration facilitates positioning at least a portion of the inner helical radiator 112 interior to the outer helical radiator 102 without the inner helical radiator 112 directly contacting the outer helical radiator 102.

The outer helical radiator 102 and the inner helical radiator 112 can be substantially helically shaped, as shown in FIG. 1. However, the invention is not so limited. Indeed, at least one of the helical radiators 102, 112 can have a modified helical shape in which the diameter 116, 118 progressively changes along a length of the radiator 102, 112. Still, other modifications to the helix shape can be made, and such modifications are within the scope of the present invention.

A dielectric member 120 can be provided to position the inner helical radiator 112 within outer helical radiator 102, while minimizing flow of direct current between the outer helical radiator 102 and the inner helical radiator 112. Moreover, the inner helical radiator 112 can be dielectrically isolated from any other components of the antenna 100.

The dielectric member 120 can be any shape suitable for disposing the inner helical radiator 112 within the outer helical radiator 102. For example, the dielectric member 120 can be T-shaped, as shown, or I-shaped. In another arrangement, the dielectric member 120 can be disposed in a region 122 defined between the inner helical radiator 112 and the outer helical radiator 102. In yet another arrangement, one or more of the radiators 102, 112 can be encapsulated in the dielectric member 120. Still, there are a myriad of other dielectric structures that can be used for positioning the inner helical radiator 112 and the invention is not limited in this regard.

In operation, the inner helical radiator 112 can electromagnetically couple to the outer helical radiator 102. This coupling can increase the level of signal current in the outer helical radiator 102, thus enabling the outer helical radiator to achieve lower transmission impedance than would otherwise be obtainable without use of the inner helical radiator 112. For example, using known impedance matching methods, the antenna 100 can operate as a half wave antenna having a transmission impedance of 50 ohms with a VSWR of 2:1, while also achieving a very low SAR. In comparison to quarter wave antenna operation, operation as a half wave antenna can have the desirable effect of maximizing transmission currents in the antenna, while minimizing transmission currents in circuit traces 126 on the printed circuit board 110.

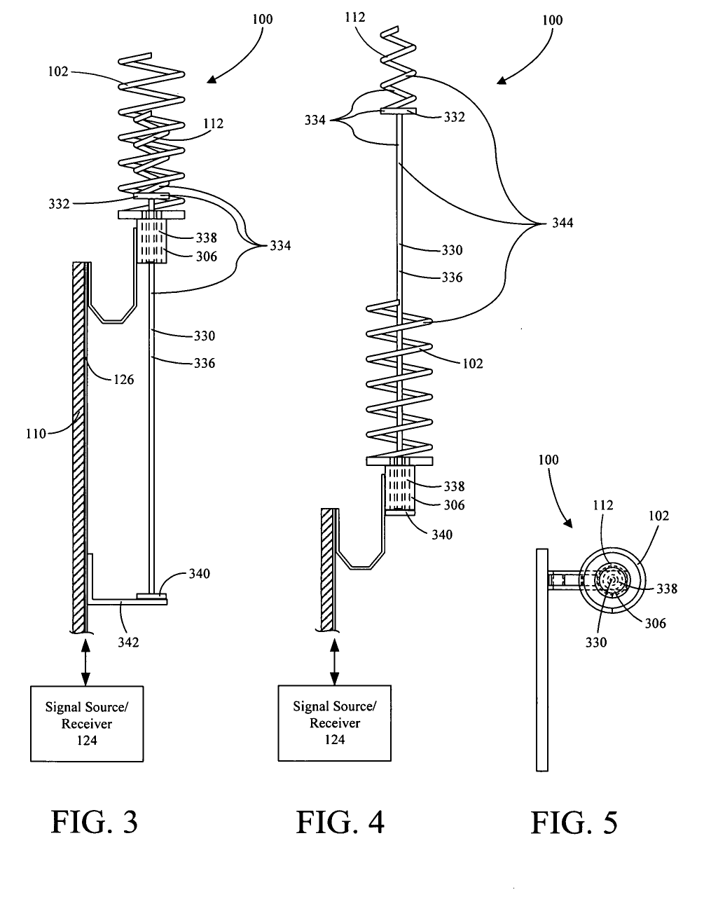

FIGS. 3-5 depict another arrangement of the antenna 100 that is useful for understanding the present invention. In addition to the inner helical radiator 112, the antenna 100 can comprise a whip 330 to which the inner helical radiator 112 is attached. The whip 330 can be moveable between a first position wherein at least a portion of the inner helical radiator 112 is positioned interior to the outer helical radiator 102, as shown in FIG. 3, and a second position wherein the inner helical radiator 112 is positioned exterior to the outer helical radiator 102, as shown in FIG. 4.

The inner helical radiator 112 can be attached to the whip 330 via an electrically conductive connector 332. Accordingly, the whip 330, connector 332 and the inner helical radiator 112 can form a radiating member 334. In another arrangement, the inner helical radiator 112 and the whip 330 can be formed from a single conductor 336, in which case the connector 332 would not be required as a component of the radiating member 334.

A dielectric member 338 that slideably engages the whip 330 can dielectrically insulate the whip 330 from a conductive member 306. Accordingly, the inner helical radiator 112 can electromagnetically couple to the outer helical radiator 102 to increase the level of signal current in the outer helical radiator 102, as previously described, while the inner helical radiator 112 and the outer helical radiator 102 are not electrically connected.

Referring to FIG. 3, a stop member 340 and stop bracket 342 can be provided to stop movement of the radiating member 334 at a selected retracted position. For instance, it may be desirable for the inner helical radiator 112 to be positioned at a specific location interior to the outer helical radiator 102 to optimize performance of the antenna 100 when the radiating member 334 is retracted. In one arrangement, the stop member 342 can be dielectrically insulated from any circuit traces 126 on the printed circuit board 110.

In another arrangement, the stop member can provide an electrical connection between the radiating member 334 and one or more circuit traces 126 on the printed circuit board 110. For example, the outer helical radiator 102 and the radiating member 334 each can be electrically connected to different portions of a circuit. Such an arrangement can provide greater flexibility in the application of impedance control devices that optimize performance of the antenna 100 when the antenna 100 is in the retracted position.

Referring to FIG. 4, the radiating member 334 can be extended such that the inner helical radiator 112 extends outward of the outer helical radiator 102. The stop member 340 can interface with the conductive member 306 to stop movement of the radiating member 334 at an appropriate position. In one arrangement, the stop member 340 can form an electrically conductive connection with the conductive member 306 so that the radiating member 334 and the outer helical radiator 102 form a single radiator 344. In another arrangement, a switch, such as one known to the skilled artisan, can be used to form the electrically conductive connection between the stop member 340 and the outer helical radiator 102.

In yet another arrangement, the bushing 340 can be formed from a dielectric material. In this arrangement, the radiating member 334 can be extended to decouple the inner helical radiator 112 from the outer helical radiator 102. For example, this could be used to capacitively couple energy from the conductive member 306 to the whip 330. Such an arrangement could allow a half-wave antenna to be formed in the extended mode, with the whip 330 and inner helical radiator 112 being the primary radiators.

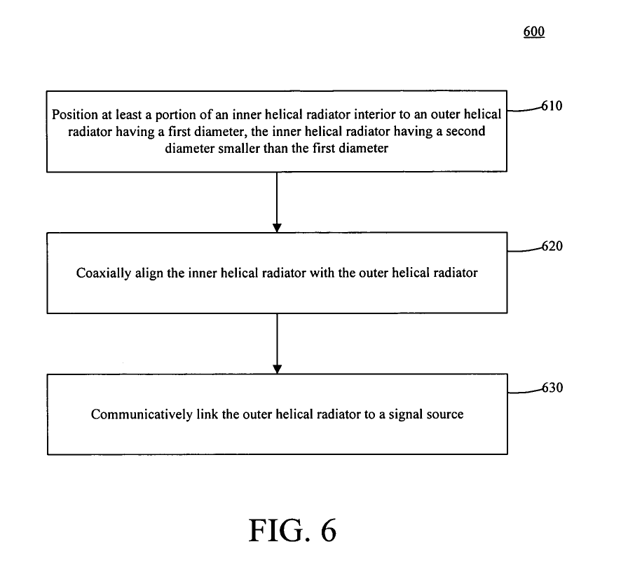

FIG. 6 is a flowchart that presents a method 600 which is useful for understanding the present invention. Beginning at step 610, at least a portion of an inner helical radiator can be positioned interior to an outer helical radiator having a first diameter. The inner helical radiator can have a second diameter smaller than the first diameter. At step 620, the inner helical radiator can be coaxially aligned with the outer radiator.

In one arrangement, the inner helical radiator can be fixed into a static position and insulated from the outer helical radiator with a dielectric member. In another arrangement, the inner helical radiator can be electrically connected to a whip such that the inner helical radiator is moveable between a first position wherein at least a portion of the inner helical radiator is positioned interior to the outer helical radiator, and a second position wherein the inner helical radiator is positioned exterior to the outer helical radiator.

At step 630, the outer helical radiator can be communicatively linked to a signal source. In the arrangement in which the inner helical radiator is moveable, the inner helical radiator can remain unconnected to the signal source when the inner helical radiator is in the first position, and the inner helical radiator can be communicatively linked to the signal source when the inner helical radiator is in the second position.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily through a conductive path, and not necessarily mechanically, e.g. linked through an electromagnetic field. The term electrically connected, as used herein, is defined as being connected via a continuously electrically conductive path (i.e. a path that, relative to the devices being connected, has low DC resistance). The term communicatively linked, as used herein, is defined as being linked via a signal path. The signal path can be a direct electrical connection having low DC resistance, but is not limited in this regard. For instance, a signal path also can comprise series components, such as capacitors, that impede or block DC current while propagating RF signals.

This invention can be embodied in other forms without departing from the spirit or essential attributes thereof. Accordingly, reference should be made to the following claims, rather than to the foregoing specification, as indicating the scope of the invention.

What is claimed is:

1. An antenna comprising:
an outer helical radiator having a first diameter; and
an inner helical radiator having a second diameter smaller than the first diameter, the inner helical radiator positioned at least in part interior to the outer helical radiator.

2. The antenna of claim 1, wherein the outer helical radiator and the inner helical radiator are substantially coaxially aligned.

3. The antenna of claim 1, further comprising a dielectric member to which the inner helical radiator is attached, wherein the dielectric member maintains the position of the inner helical radiator.

4. The antenna of claim 1, wherein the outer helical radiator is communicatively linked to a signal source.

5. The antenna of claim 1, further comprising a whip to which the inner helical radiator is attached.

6. The antenna of claim 5, wherein the inner helical radiator is movable between a first position wherein at least a portion of the inner helical radiator is positioned interior to the outer helical radiator and a second position wherein the inner helical radiator is positioned exterior to the outer helical radiator.

7. The antenna of claim 6, further comprising a dielectric member that insulates the inner helical radiator from the outer helical radiator when the inner helical radiator is in the first position.

8. The antenna of claim 7, wherein the outer helical radiator is communicatively linked to a signal source, and the inner helical radiator is communicatively linked to the signal source when the inner helical radiator is in the second position.

9. An antenna comprising:
an outer helical radiator having a first diameter; and
an inner helical radiator having a second diameter smaller than the first diameter, the inner helical radiator being movable between a first position wherein at least a portion of the inner helical radiator is positioned interior to the outer helical radiator and a second position wherein the inner helical radiator is positioned exterior to the outer helical radiator.

10. The antenna of claim 9, wherein the outer helical radiator and the inner helical radiator are substantially coaxially aligned.

11. The antenna of claim 9, further comprising a dielectric member that insulates the inner helical radiator from the outer helical radiator when the antenna is in the first position.

12. The antenna of claim 9, further comprising a whip to which the inner helical radiator is attached.

13. The antenna of claim 9, further comprising a conductive member that provides electrical continuity between the inner helical radiator and the outer helical radiator when the antenna is in the second position.

14. The antenna of claim 9, wherein the outer helical radiator is communicatively linked to a signal source.

15. The antenna of claim 14, wherein the inner helical radiator is communicatively linked to the signal source when the inner helical radiator is in the second position.

16. A method for tuning performance characteristics of an antenna comprising:
positioning at least a portion of an inner helical radiator interior to an outer helical radiator having a first diameter, the inner helical radiator having a second diameter smaller than the first diameter.

17. The method according to claim 16, further comprising coaxially aligning the outer helical radiator and the inner helical radiator.

18. The method according to claim 16, wherein said positioning the inner helical radiator comprises insulating the inner helical radiator from the outer helical radiator with a dielectric member.

19. The method according to claim 16, further comprising electrically connecting the inner helical radiator to a whip such that the inner helical radiator is movable between a first position wherein at least a portion of the inner helical radiator is positioned interior to the outer helical radiator, and a second position wherein the inner helical radiator is positioned exterior to the outer helical radiator.

20. The method according to claim 19, further comprising communicatively linking the outer helical radiator to a signal source, wherein the inner helical radiator is not connected to the signal source when the inner helical radiator is in the first position, and the inner helical radiator is communicatively linked to the signal source when the inner helical radiator is in the second position.
